(19) United States
(12) Patent Application Publication
(10) Pub. No.: US 2016/0057093 A1
(43) Pub. Date: Feb. 25, 2016

(54) METHOD AND APPARATUS FOR DISPLAYING CONTENT

(71) Applicant: Samsung Electronics Co., Ltd., Gyeonggi-do (KR)

(72) Inventors: You-Bi SEO, Seoul (KR); Ananya VETAL, Noida (IN); Ankur GUPTA, Meerut (IN); Ankur SARDANA, New Delhi (IN); Yoon-Sun CHO, Seoul (KR); Hwa-Youn SUH, Seoul (KR)

(21) Appl. No.: 14/643,133

(22) Filed: Mar. 10, 2015

(30) Foreign Application Priority Data
Aug. 19, 2014 (IN) 4041/CHE/2014
Oct. 6, 2014 (KR) 10-2014-0133994

(51) Int. Cl. H04L 12/58; G06F 3/0484

(52) U.S. Cl. CPC H04L 51/32; G06F 3/04842; H04L 51/22

(57) ABSTRACT

A method is provided comprising: displaying a first screen including a plurality of messages received from at least a first contact and a second contact; detecting a selection of the first contact; in response to the selection, hiding from the first screen a first message in the plurality that is received from the first contact.

### CLAIM OF PRIORITY

This application claims the benefit under 35 U.S.C. §119(a) to an Indian Non-Provisional Patent Application No. 4041/CHE/2014 filed on Aug. 19, 2014 and a Korean Patent Application No. 10-2014-0133994 filed on Oct. 6, 2014, the disclosure of which is hereby incorporated by reference herein.

### TECHNICAL FIELD

Various embodiments of the present disclosure relate to electronic devices, and more particularly to a method and apparatus for displaying content.

### BACKGROUND

In these days, electronic devices including tablet PCs, smart phones, and the like provide a telephone call service, a short message service, and a messenger service, and users using the above-described services with the electronic devices can easily chat with each other. In particular, the number of users using the messenger service through a 3G network, a 4G network, or a Wi-Fi network is rapidly increasing.

Meanwhile, the messenger service provides a service for sharing not only text messages, but also photos, videos, and the like in the chat window. Furthermore, the chat window of the messenger service provides not only a one-to-one chat service between users using the messenger service but also a group chat service by which the users (hereinafter, also referred to as members) using the messenger service can chat with each other in one group. In addition, technologies are being actively developed to provide the users with a greater variety of functions of the messenger service.

### SUMMARY

According to aspects of the disclosure, a method is provided comprising: displaying a first screen including a plurality of messages received from at least a first contact and a second contact; detecting a selection of the first contact; in response to the selection, hiding from the first screen a first message in the plurality that is received from the first contact.

According to aspects of the disclosure, an electronic device is provided comprising a controller configured to: display a first screen including a plurality of messages received from at least a first contact and a second contact; detect a selection of the first contact; in response to the selection, hide from the first screen a first message in the plurality that is received from the first contact.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a block diagram of an example of an electronic device, according to aspects of the disclosure;

FIG. 2 is a flowchart of an example of a process, according to aspects of the disclosure;

FIG. 3 is a flowchart of an example of a process for operating a user interface, according to aspects of the disclosure;

FIG. 4A, FIG. 4B, FIG. 4C, FIG. 4D, FIG. 4E and FIG. 4F are diagrams of an example of the user interface of FIG. 3, according to aspects of the disclosure;

FIG. 5 is a flowchart of an example of a process for operating a user interface, according to aspects of the disclosure;

FIG. 6A, FIG. 6B and FIG. 6C are diagrams of an example of the user interface of FIG. 5, according to aspects of the disclosure;

FIG. 7 is a flowchart of an example of a process, according to aspects of the disclosure; and

FIG. 8 is a block diagram of an example of an electronic device according to aspects of the disclosure.

### DETAILED DESCRIPTION

Hereinafter, various embodiments of the present disclosure will be described with reference to enclosed drawings. The present disclosure may be modified in various forms and include various embodiments. Although specific examples are illustrated in the drawings and described in the description, the description is not intended to limit the present disclosure to the specific embodiments, and it shall be appreciated that all the changes, equivalents and substitutions belonging to the idea and technical scope of the present disclosure are included in the present disclosure. In the description of the drawings, identical or similar reference numerals are used to designate identical or similar elements.

The term “include” or “may include” refers to the existence of a corresponding disclosed function, operation or component which can be used in various embodiments of the present disclosure and does not limit one or more additional functions, operations, or components. Further, as used in various embodiments of the present disclosure, the terms “include”, “have” and their conjugates may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

In various embodiments of the present disclosure, the expression “or” or “at least one of A or/and B” includes any or all of combinations of words listed together. For example, the expression “A or B” or “at least A or/and B” may include A, may include B, or may include both A and B.

The expression “1”, “2”, “first”, or “second” used in various embodiments of the present disclosure may modify various components of various embodiments but does not limit the corresponding components. For example, the above expressions do not limit the sequence and/or importance of the corresponding elements. The expressions may be used to distinguish a component element from another component element. For example, a first user device and a second user device indicate different user devices although both of them are user devices. For example, without departing from the scope of the present disclosure, a first component element may be named a second component element. Similarly, the second component element also may be named the first component element.

It should be noted that if it is described that one component element is “coupled” or “connected” to another component element, the first component element may be directly coupled or connected to the second component, and a third component element may be “coupled” or “connected” between the first and second component elements. Conversely, when one component element is “directly coupled” or “directly connected” to another component element, it may be construed that a third component element does not exist between the first component element and the second component element.

In the present disclosure, the terms are used to describe a specific embodiment, and are not intended to limit the present disclosure. As used herein, the singular forms are intended to include the plural forms as well, unless the context clearly indicates otherwise.

Unless defined differently, all terms used herein, which include technical terminologies or scientific terminologies, have the same meaning as a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

Electronic devices according to various embodiments of the present disclosure may be devices adopting a communication function. For example, the electronic devices may include at least one of smart phones, tablet personal computers (PCs), mobile phones, video phones, e-book readers, desktop PCs, laptop PCs, netbook computers, personal digital assistants (PDAs), portable multimedia players (PMPs), MP3 players, mobile medical devices, cameras, wearable devices {e.g., head-mounted-devices (HMDs) such as electronic glasses}, electronic clothes, electronic bracelets, electronic necklaces, electronic appcessories, electronic tattoos, or smart watches.

According to an embodiment, an electronic device may be a smart home appliance with a communication function. The smart home appliance as an example of the electronic device may include at least one of, for example, a television, a Digital Video Disk (DVD) player, an audio system, a refrigerator, an air conditioner, a vacuum cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, and an electronic picture frame.

According to an embodiment, an electronic device may include at least one of various medical devices such as a magnetic resonance angiography (MRA) scanner, a magnetic resonance imaging (MRI) scanner, a computed tomography (CT) scanner, a scanner, an ultrasonograph, or the like, a navigation device, a Global Positioning System (GPS) receiver, an Event Data Recorder (EDR), a Flight Data Recorder (FDR), a vehicle infotainment device, an electronic equipment for ship (for example a ship navigation device and gyro-compass and the like, avionics, a security device, a head unit for vehicle, an industrial or household robot, ATM(automatic teller machine) in banking facilities or POS(point of sales) in stores.

According to another embodiment, the electronic devices may include at least one of furniture or a part of a building/structure having a communication function, electronic boards, electronic signature receiving devices, projectors, or various measuring equipment (e.g., equipment for a water supply, electricity, gases or radio waves). An electronic device according to various embodiments of the present disclosure may be a combination of one or more of above-described various devices. Also, an electronic device according to various embodiments of the present disclosure may be a flexible device. Also, an electronic device according to various embodiments of the present disclosure is not limited to the above-described devices.

The term “user” used in various embodiments may refer to a person who uses an electronic device or a device (for example, an artificial intelligence electronic device) that uses an electronic device.

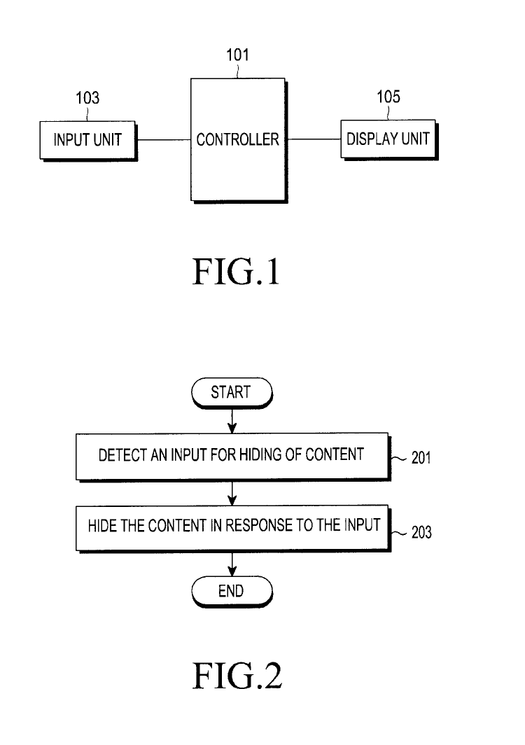

FIG. 1 is a block diagram of an example of an electronic device, according to aspects of the disclosure. Referring to FIG. 1, the electronic device may include a controller 101, an input unit 103, and a display unit 105.

The input unit 103 may receive an input of a user manipulation, and may be configured with a touch screen (not illustrated) which will be described below. The input unit 103 may include at least one of a power/lock button and a menu button which may be formed on a front, side, or rear surface of a housing of the electronic device, and may further include a microphone (not illustrated).

The display unit 105 may display an execution image, an operating state, a menu state, and the like of various application programs, and may be implemented with a touch screen and a touch screen controller (not illustrated) which will be described below.

The touch screen may receive an input of a user manipulation and display an execution image, an operating state, and a menu state of an application program. That is, the touch screen may provide a user with a user interface corresponding to various services (e.g., a telephone call, data transmission, broadcasting, and photographing). The touch screen may transmit an analog signal corresponding to at least one touch input to the user interface to the touch screen controller. The touch screen may receive at least one touch caused by a user's body (e.g., fingers including a thumb) or a touchable input means (also, referred to as a pen; e.g., a stylus pen). Also, the touch screen may receive a continuous movement of one of at least one touch. The touch screen may transmit an analog signal corresponding to the continuous movement of the touch input thereto to the touch screen controller.

The touch is not limited to direct contact between the touch screen and the user's body or the touchable input means, and may include non-contact. The gap which can be detected by the touch screen may vary with a capability or a structure of the electronic device, and in particular, the touch screen may be configured such that values (e.g., current values) detected by a touch event and a hovering event may be differently output for separate detection of the touch event by the contact between the touch screen and the user's body or the touchable input means and the input event (e.g., the hovering event) in a contactless status. In addition, the touch screen may differently output the detected value (e.g., current value) according to a distance between a space where the hovering event is generated and the touch screen.

The touch screen may be implemented, for example, in a resistive type, a capacitive type, an infrared type, or an acoustic wave type.

Meanwhile, the touch screen controller converts the analog signal received from the touch screen to a digital signal (e.g., X and Y coordinates) and transmits the digital signal to the controller 101. The controller 101 may control the touch screen using the digital signal received from the touch screen controller. For example, the controller 101 enables a shortcut icon (not illustrated) displayed on the touch screen to be selected or executed in response to the touch event or the hovering event. Furthermore, the touch screen controller may also be included in the controller 101.

In addition, the touch screen controller may identify the distance between the space where the hovering event is generated and the touch screen by detecting the value (e.g., current value) output through the touch screen, and may convert the identified distance value to a digital signal (e.g., a Z coordinate) to provide the digital signal to the controller 101.

Moreover, the touch screen may include at least two touch screen panels which may detect a touch or proximity of the user's body or the touchable input means so as to simultaneously receive inputs by the user's body and the touchable input means. The at least two touch screen panels may provide different output values to the screen controller, and the touch screen controller may differently recognize the values input from the at least two touch screen panels to distinguish whether the input from the touch screen is an input by the user's body or an input by the touchable input means.

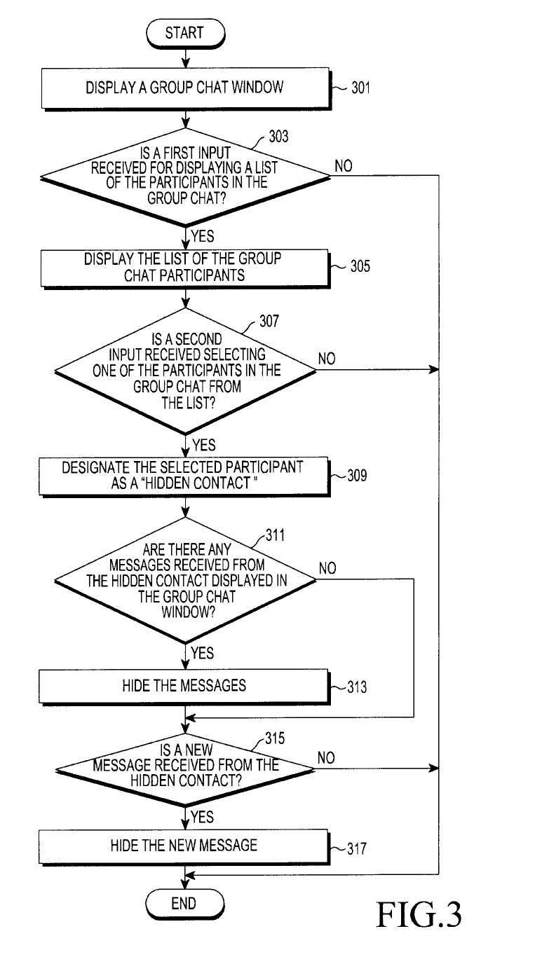

The controller 101 may include any suitable type of processing circuitry, such as a general purpose process (e.g., an ARM-based processor, an Application Specific Integrated Circuit (ASIC), a Field Programmable Gate Array (FPGA), a Digital Signal Processor (DSP), etc. The controller 101 may include a Central Processing Unit (CPU, not illustrated), a Read Only Memory (ROM, not illustrated) storing a control program for controlling the electronic device, and a Random Access Memory (RAM, not illustrated) which stores signals or data input from the outside of the electronic device or is used as a storage region for tasks performed by the electronic device. The CPU (not illustrated) may include a single core CPU, a dual core CPU, a triple core CPU, or a quad core CPU. The CPU (not illustrated), the ROM (not illustrated) and the RAM (not illustrated) may be connected with each other through an internal bus. In some implementations, the controller 101 may be configured to perform any one of the processes described with respect to FIGS. 2-7.

FIG. 2 is a flowchart of an example of a process, according to aspects of the disclosure. According to the process, in operation 201, an electronic device may detect an input for hiding of content from a screen that is displayed by the electronic device. For example, the user input may be a press of a button, a touch input, a voice input, or the like. The screen may be any suitable type of screen. For example, the screen may be a chat window in a messenger application or a phone book (contact) screen. The content may be, for example, an icon, a video, a still image, text, or the like.

In operation 203, the electronic device may hide the content in response to the input. For example, the electronic device may reduce the size of the content, configured as a target to be hidden, at a designated rate and display the reduced content instead of the configured content. Furthermore, the electronic device may extract only some configurations(e.g. text, image, etc) from the content according to a designated standard and display only the extracted configuration instead of the configured content. Moreover, the electronic device may display a designated icon, image, or text instead of the content configured as the target to be hidden.

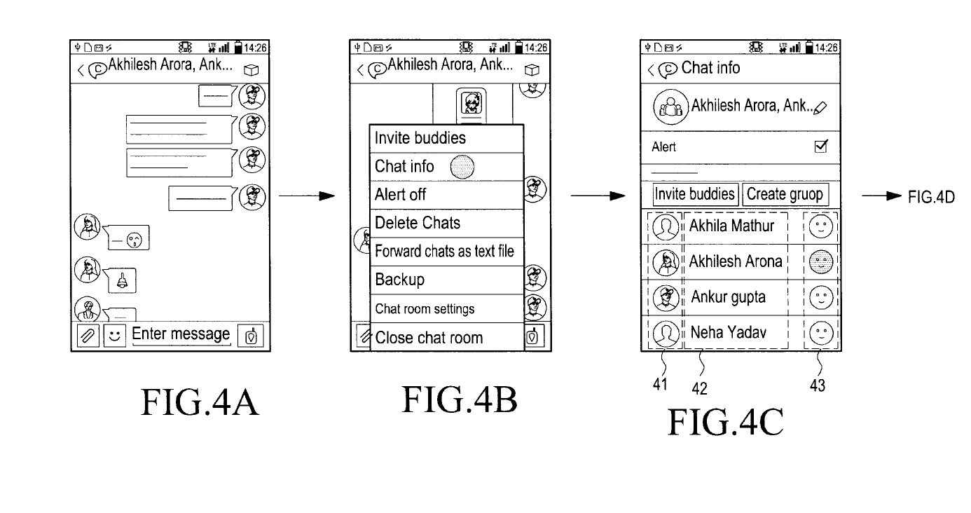

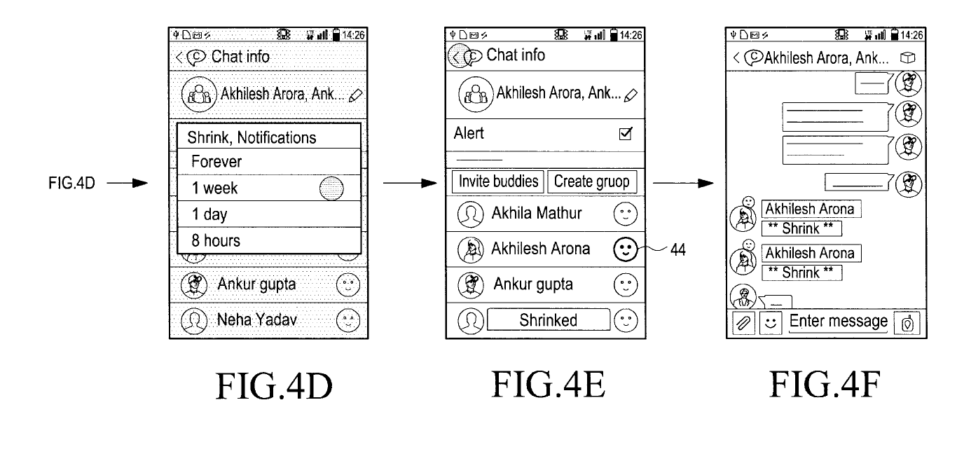

FIG. 3 is a flowchart of an example of a process for operating a user interface, according to aspects of the disclosure. FIGS. 4A-F, are diagrams of an example of the user interface, according to aspects of the disclosure.

In operation 301, the electronic device may display a group chat window. The group chat window may be displayed as a result of executing a messaging application. For example, as illustrated in FIG. 4A, the group chat window may allow a plurality of users to share messages, such as text messages, emoticons, photos, videos, and the like.

In operation 303, the electronic device may determine whether a first input is received for displaying a list of the participants in the group chat. When the first input is received, the process proceeds to operation 305. Otherwise the process ends.

In operation 305, the electronic device may display the list of the group chat participants. In addition, the electronic device may present one or more input components (e.g., buttons) for configuring messages received from different chat participants as targets to be hidden. Each one of the input components may be selected according to a user input such as a touch, a voice input, or the like.

For example, as illustrated in FIG. 4B, the electronic device may display, a popup window through which different functions may be selected. When any one of the functions is selected, that function is executed. For example, when “Chat Info” option is selected, as illustrated in FIG. 4C, the electronic device may display, on the screen, a list containing profile photos 41, names 42, and configuration buttons 43 for configuring input messages received from different contacts as targets to be hidden.

In operation 307, the electronic device may determine whether a second input is received selecting one of the participants in the group chat from the list. If the second input is received, the process proceeds to operation 309. Otherwise, the process ends.

In operation 309, the electronic device may designate the selected participant as a “hidden contact”. For example, when it is detected that the group chat participant “Akhilesh Arona” is selected, as illustrated in FIG. 4C, the electronic device may display a screen to configure a period for which messages received from “Akhilesh Arona” are to be hidden, as illustrated in FIG. 4D. When “1 week” is selected, all (or at least some) messages that are received from “Akhilesh Arona” may be hidden for a week.

Additionally or alternatively, an indication may be output that indicates that messages received from Akhilesh Arona are currently being hidden (e.g., an indication that Akhilesh Arona is a “hidden contact”). For example, as illustrated in FIG. 4E, the state of the button 44 for may be changed in order to represent that the button 44 has been selected and that “Akhilesh Arona” is currently a hidden contact as a result of the button 44's selection.

In operation 311, the electronic device may determine whether any messages received from the hidden contact are currently displayed in the group chat window. When such messages are displayed, the process proceeds to operation 313. Otherwise, the process proceeds to operation 315.

In operation 313, the electronic device may hide all (or at least some) messages received from the hidden contact that are currently displayed in the group chat window. In some implementations, hiding a given one of the messages may include displaying a designated text (e.g., a placeholder) at the location in the group chat window where the message was previously displayed.

For example, when a message received from “Akhilesh Arona” is hidden, as illustrated in FIG. 4F, the electronic device may display a designated text at the point where the input message was displayed. Additionally or alternatively, as illustrated in FIG. 4F, the electronic device may display an indicator (e.g., an emoticon), representing that the input message of “Akhilesh Arona” is hidden, on a profile photo of “Akhilesh Arona”.

In operation 315, the electronic device may detect whether a new message is received from the “hidden contact”. When a new message is received, the process proceeds to operation 317. Otherwise the process ends.

In operation 317, the electronic device may hide the new message. For example, the electronic device may display a placeholder (e.g., a designated icon, a designated text, etc.) in place of the newly-received message. In this way, the electronic device may apprise its user of any incoming messages that are received from the “hidden contact” without actually displaying those messages.

Although the above example is presented in the context of a group chat, it is to be understood that the disclosure is not limited to designating only users who participate in a group chat as “hidden contact”. For example, in some implementations, the designation of a user as a “hidden contact” may be made by using any suitable list of users (e.g., a contacts list, a phone book, etc.), without regard to whether any of the users is participating in a particular communications session.

According to the above-described example, when a specific group chat participant is selected from a list, and a button (also, referred to as a shrink button) for allowing a received message to be hidden is pushed, an option (referred to as a concealment-period configuration option) may be provided for selecting a duration for which messages received from the selected group chat participant are to be hidden. Additionally or alternatively, the messages the duration may be set automatically without the need for the user to specify it manually.

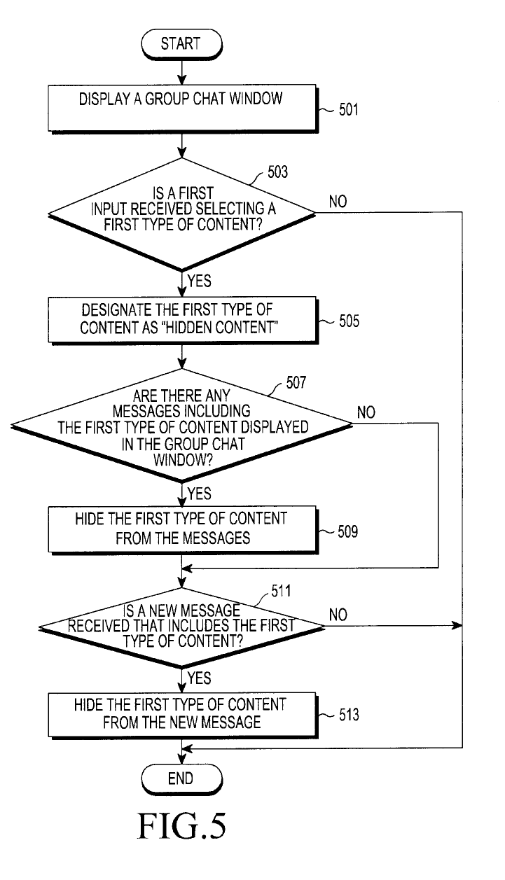

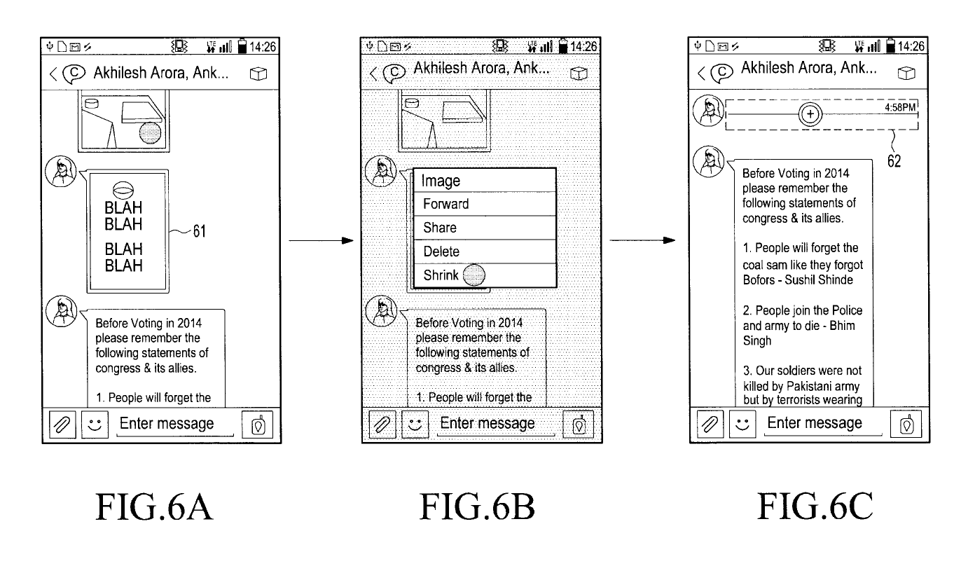

FIG. 5 is a flowchart of an example of a process for operating a user interface, according to aspects of the disclosure. FIGS. 6A-C, are diagrams of an example of the user interface, according to aspects of the disclosure.

In operation 501, the electronic device may display a group chat window. The group chat window may be displayed as a result of executing a messaging application.

In operation 503, the electronic device may detect whether a first input is received selecting a first type of content. The first type of content may include any suitable type of content, such as image content, text content, video content, etc. When the first input is received, the process proceeds to operation 505. Otherwise, the process ends.

In operation 505, the electronic device may designate the first type of content as “hidden content.”

In operation 507, the electronic device may detect whether there are any messages in the group chat window that include the first type of content (i.e., the hidden content). When such messages are present, the process proceeds to operation 509. Otherwise, the process proceeds to operation 511.

In operation 509, the electronic device may hide the first type of content from all (or at least some) messages included in the group chat window (or all messages exchanged over the course of the group chat that include the first type of content). In some implementations, hiding the first type of content may include removing one or more content items from display and presenting a placeholder in place of the removed content items. The placeholder may be an image, an icon, text, and/or any other suitable type of placeholder. Additionally or alternatively, in some implementations, hiding the first type of content may include hiding the messages that include the first type of content altogether or hiding only content items of the first type from the messages while permitting other portions of the messages to remain visible.

For example, when, as illustrated in FIG. 6A, identifying an input of a long press (a gesture input in which a finger is touched on the screen for a predetermined period of time and then released) to an image 61 which is part of one of the messages in the group chat window, the electronic device may display, on the screen, functional options that may be performed on the corresponding message, such as “forward”, “share”, “delete”, and “shrink”, as illustrated in FIG. 6B. When the “shrink” functional option is selected, image content (e.g., bitmap images, jpeg images, etc.) may be designated as “hidden content.” Accordingly, as illustrated in FIG. 6C, the electronic device may stop displaying the selected image and instead display a designated icon 62 on the screen. Furthermore, the electronic device may also stop displaying in the group chat window all other images that are included in the group chat window (or all images that that have been exchanged over the course of the group chat).

In operation 511, the electronic device may detect whether a new message is received that includes the first type of content. When such message is received, the process proceeds to operation 513. Otherwise, the process ends.

In operation 513, the electronic device may hide the first type of content from the new message. In some implementations, the electronic device may display a placeholder (e.g., a generic icon) in place of the content and/or the new message. In this way, the electronic device may apprise its user of any incoming messages that are received that include content items from the hidden type without actually displaying those content items.

According to the above-described embodiment, when specific content is shared (input) in the chat window of the messenger service, a popup window associated with the specific content may provide a shrink function. For example, when a message is pressed long, the popup window may provide functional options (e.g., copy, transfer, delete, and the like) which may be performed on the corresponding message. According to the above-described embodiment, a function of hiding content (shrink function) is added to the popup window, and when a function of hiding specific content is performed according to a user manipulation, content of the same type as the specific content may be hidden for a predetermined period of time.

Although in the above example, content to be hidden is selected from a screen that includes a plurality of messages exchanged over the course of a conversation, it is to be understood that a particular type of content may be designated as “hidden content” by using any suitable type of screen, menu, and/or list. Moreover, although the above example is presented in the context of a group chat, it is to be understood that in some implementations content may be hidden from any suitable type of communications session, such as a one-on-one chat.

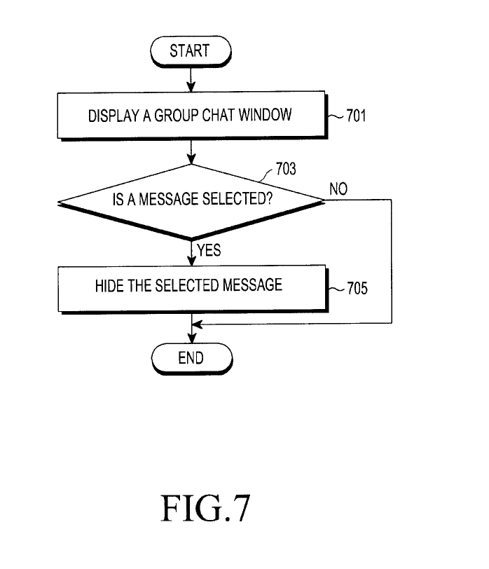

FIG. 7 is a flowchart of an example of a process, according to aspects of the disclosure.

In operation 701, the electronic device may display a group chat window. The group chat window may be displayed as a result of executing a messaging application. In operation 703, the electronic device may detect whether a particular message in the group chat window is selected. The message may be selected via any suitable type of input, such as a long tap or a swipe (a gesture in which one finger is touched on a screen and horizontally or vertically moves by a predetermined distance).

In operation 705, the electronic device may hide the selected message. For example, When the electronic device identifies an input of a long tap for selecting the message in the chat window of the messenger service, a contextual popup window associated with the message may be displayed on the screen. The pop window may include an input component (e.g., a menu option, a button, etc.) for selecting a function for hiding the message selected in the popup window (a shrink function). Afterwards, when the input component is selected (or activated), the electronic device may hide the selected message. In some implementations, hiding the selected message may include displaying a placeholder at a location in the group chat screen where the message was previously displayed.

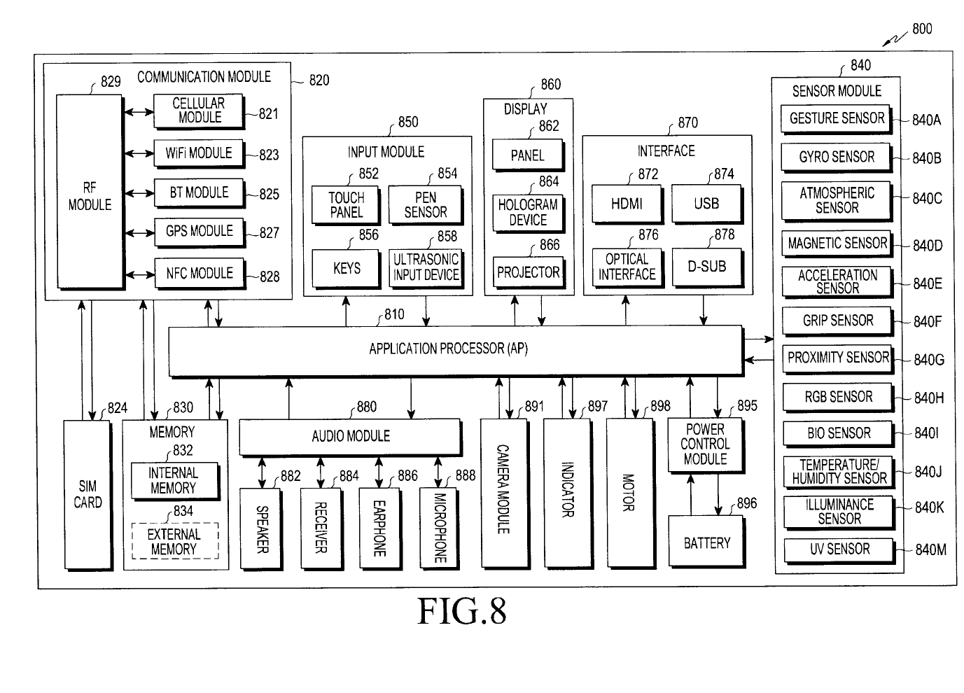

FIG. 8 is a block diagram of an example of an electronic device according to aspects of the disclosure.

Referring to FIG. 8, the electronic device 800 may include at least one application processor (AP) 810, a communication module 820, a Subscriber Identification Module (SIM) card 824, a memory 830, a sensor module 840, an input module 850, a display 860, an interface 870, an audio module 880, a camera module 891, a power management module 895, a battery 896, an indicator 897, and a motor 898.

The AP 810 may control a plurality of hardware or software components connected thereto by driving an operating system or an application program, process various data including multimedia data, and perform calculations. The AP 810 may be implemented as, for example, a System on Chip (SoC). According to an embodiment, the AP 810 may further include a Graphic Processing Unit (GPU, not illustrated).

The communication module 820 may transmit/receive data in communication between the electronic device 800 and other electronic devices connected with the electronic device 800 through a network. According to an embodiment, the communication module 820 may include a cellular module 821, a Wi-Fi module 823, a Bluetooth (BT) module 825, a Global Positioning System (GPS) module 827, a Near Field Communication (NFC) module 828, and a Radio Frequency (RF) module 829.

The cellular module 821 may provide a voice call, a video call, a Short Message Service (SMS), an Internet service, and the like through a communication network (e.g., Long Term Evolution (LTE), LTE-Advanced (LTE-A), Code Division Multiple Access (CDMA), Wideband CDMA (WCDMA), Universal Mobile Telecommunication System (UMTS), Wireless Broadband (WiBro), or Global System for Mobile communication (GSM)). Furthermore, the cellular module 821 may distinguish and authenticate electronic devices within a communication network using a subscriber identification module (e.g., the SIM card 824). According to an embodiment, the cellular module 821 may perform at least some functions which may be provided by the AP 810. For example, the cellular module 821 may perform at least a part of a multimedia control function.

According to an embodiment, the cellular module 821 may include a Communication Processor (CP). Furthermore, the cellular module 821 may be implemented as, for example, a SoC. Although the components such as the cellular module 821 (e.g., communication processor), the memory 830, and the power managing module 895 are illustrated as components separate from the AP 810 in FIG. 8, the AP 810 may include at least some of the above-described components (e.g., the cellular module 821) according to an embodiment.

According to an embodiment, the AP 810 or the cellular module 821 (e.g., the communication processor) may load commands or data received from at least one of a non-volatile memory and other components connected thereto in a volatile memory and process the loaded commands or data. Furthermore, the AP 810 or the cellular module 821 may store data received from or generated by at least one of the other components in a non-volatile memory.

The Wi-Fi module 823, the BT module 825, the GPS module 827, and the NFC module 828 may include, for example, a processor for processing data transmitted/received through the corresponding module. Although the cellular module 821, the Wi-Fi module 823, the BT module 825, the GPS module 827, and the NFC module 828 are illustrated as individual blocks in FIG. 8, at least some (e.g., two or more) of the cellular module 821, the Wi-Fi module 823, the BT module 825, the GPS module 827, and the NFC module 828 may be included within one Integrated Chip (IC) or one IC package. For example, at least some (e.g., the communication processor corresponding to the cellular module 821 and the Wi-Fi processor corresponding to the Wi-Fi module 823) of the processors corresponding to the cellular module 821, the Wi-Fi module 823, the BT module 825, the GPS module 827, and the NFC module 828 may be implemented as one SoC.

The RF module 829 may transmit/receive data, for example, an RF signal. Although not illustrated, the RF module 829 may include, for example, a transceiver, a Power Amp Module (PAM), a frequency filter, a Low Noise Amplifier (LNA), and the like. Furthermore, the RF module 829 may further include a component, such as a conductor, a conductive wire, or the like, for transmitting/receiving an electromagnetic wave in a free space in wireless communication. Although the cellular module 821, the Wi-Fi module 823, the BT module 825, the GPS module 827, and the NFC module 828 share one RF module 829 in FIG. 8, at least one of the cellular module 821, the Wi-Fi module 823, the BT module 825, the GPS module 827, and the NFC module 828 may transmit/receive the RF signal through a separate RF module.

The SIM card 824 may be a card including a subscriber identification module, and may be inserted into a slot formed in a particular position of the electronic device. The SIM card 824 may include unique identification information (e.g., an Integrated Circuit Card IDentifier (ICCID)) or subscriber information (e.g., International Mobile Subscriber Identity (IMSI)).

The memory 830 may include an internal memory 832 or an external memory 834. The internal memory 832 may include at least one of a volatile memory (e.g., a Dynamic Random Access Memory (DRAM), a Static RAM (SRAM), a Synchronous Dynamic RAM (SDRAM), and the like) and a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, a NOR flash memory, and the like).

According to an embodiment, the internal memory 832 may be a Solid State Drive (SSD). The external memory 834 may further include a flash drive, for example, a Compact Flash (CF), a Secure Digital (SD), a Micro Secure Digital (Micro-SD), a Mini Secure Digital (Mini-SD), an extreme Digital (xD), a memory stick, or the like. The external memory 834 may be functionally connected with the electronic device 800 through various interfaces. According to an embodiment, the electronic device 800 may further include a storage device (or storage medium) such as a hard disk drive.

The sensor module 840 may measure a physical quantity or detect an operating state of the electronic device 800, and may convert the measured or detected information to an electronic signal. The sensor module 840 may include, for example, at least one of a gesture sensor 840A, a gyro sensor 840B, an atmospheric pressure sensor 840C, a magnetic sensor 840D, an acceleration sensor 840E, a grip sensor 840F, a proximity sensor 840G, a color sensor 840H (e.g., Red, Green, and Blue (RGB) sensor), a biometric sensor 840I, a temperature/humidity sensor 840J, an illumination sensor 840K, and an Ultra Violet (UV) sensor 840M. Additionally or alternatively, the sensor module 840 may include, for example, an E-nose sensor (not illustrated), an ElectroMyoGraphy (EMG) sensor (not illustrated), an ElectroEncephaloGram (EEG) sensor (not illustrated), an ElectroCardioGram (ECG) sensor (not illustrated), an InfraRed (IR) sensor, an iris sensor (not illustrated), a fingerprint sensor, or the like. The sensor module 840 may further include a control circuit for controlling at least one or more sensors included therein.

The input device 850 may include a touch panel 852, a (digital) pen sensor 854, a key 856, or an ultrasonic input device 858. The touch panel 852 may recognize a touch input through at least one of, for example, a capacitive type, a resistive type, an infrared type, and an acoustic wave type. The touch panel 852 may further include a control circuit. The capacitive type touch panel may recognize physical contact or proximity. The touch panel 852 may also further include a tactile layer. In this case, the touch panel 852 may provide a user with a tactile reaction.

The (digital) pen sensor 854 may be implemented, for example, using a method identical or similar to a method of receiving a touch input of a user, or using a separate recognition sheet. The key 856 may include, for example, a physical button, an optical key, or a keypad. The ultrasonic input device 858 may detect an acoustic wave with a microphone (e.g., a microphone 888) of the electronic device 800 through an input tool for generating an ultrasonic signal to identify data, and wireless recognition is possible therethrough. According to an embodiment, the electronic device 800 may receive a user input from an external device (e.g., a computer or server) connected to the electronic device 800 using the communication module 820.

The display 860 may include a panel 862, a hologram device 864, or a projector 866. The panel 862 may be, for example, a Liquid Crystal Display (LCD), an Active-Matrix Organic Light Emitting Diode (AM-OLED), or the like. The panel 862 may be implemented to be, for example, flexible, transparent, or wearable. The panel 862 may also be configured as one module together with the touch panel 852. The hologram device 864 may show a stereoscopic image in the air using interference of light. The projector 866 may project light onto a screen to display an image. For example, the screen may be located inside or outside the electronic device 800. According to an embodiment, the display 860 may further include a control circuit for controlling the panel 862, the hologram device 864, or the projector 866.

The interface 870 may include, for example, a High-Definition Multimedia Interface (HDMI) 872, a Universal Serial Bus (USB) 874, an optical interface 876, or a D-subminiature (D-sub) 878. Additionally or alternatively, the interface 870 may include, for example, a Mobile High-definition Link (MHL) interface, a Secure Digital (SD) card/Multi-Media Card (MMC) interface, or an Infrared Data Association (IrDA) standard interface.

The audio module 880 may bilaterally convert a sound and an electronic signal. The audio module 880 may process voice information input or output through, for example, a speaker 882, a receiver 884, earphones 886, the microphone 888, or the like.

The camera module 891 may capture a still image or a moving image, and according to an embodiment, may include one or more image sensors (e.g., a front sensor or a rear sensor), a lens (not illustrated), an Image Signal Processor (ISP) (not illustrated), or a flash (not illustrated) (e.g., an LED or a xenon lamp).

The power management module 895 may manage power of the electronic device 800. Although not illustrated, the power management module 895 may include, for example, a Power Management Integrated Circuit (PMIC), a charger Integrated Circuit (IC), or a battery or fuel gauge.

The PMIC may be mounted to, for example, an integrated circuit or a SoC semiconductor. Charging methods may be classified into a wired charging method and a wireless charging method. The charger IC may charge a battery and prevent over voltage or over current from being introduced from a charger. According to an embodiment, the charger IC may include a charger IC for at least one of the wired charging method and the wireless charging method. A magnetic resonance scheme, a magnetic induction scheme, or an electromagnetic scheme may be exemplified as the wireless charging method, and an additional circuit for wireless charging, such as a coil loop circuit, a resonance circuit, a rectifier circuit, and the like may be added.

The battery gauge may measure, for example, a remaining quantity of the battery 896, or a voltage, a current, or a temperature during the charging. The battery 896 may store or generate electricity, and may supply power to the electronic device 800 using the stored or generated electricity. The battery 896 may include, for example, a rechargeable battery or a solar battery.

The indicator 897 may display a particular status of the electronic device 800 or a part thereof (e.g., the AP 810), for example, a booting status, a message status, a charging status, or the like. The motor 898 may convert an electrical signal to mechanical vibration. Although not illustrated, the electronic device 800 may include a processing unit (for example, GPU) for mobile TV support. The processing unit for supporting the mobile TV may process, for example, media data according to a standard of a Digital Multimedia Broadcasting (DMB), a Digital Video Broadcasting (DVB), a media flow or the like.

The described component elements of an electronic device according to various embodiments of the present disclosure may be formed of one or more components, and a name of a corresponding component element may be changed based on a type of electronic device. An electronic device according to various embodiments of the present disclosure may be formed to include at least one of the described component elements, and a few component elements may be omitted or additional component elements may be further included. Furthermore, some of the elements of the electronic device according to the various embodiments of the present disclosure may be combined to form a single entity, and thus, may equivalently execute functions of the corresponding elements prior to the combination.

The “module” used in various embodiments of the present disclosure may refer to, for example, a “unit” including one of hardware, software, and firmware, or a combination of two or more of the hardware, software, and firmware. The “module” may be interchangeable with a term, such as a unit, a logic, a logical block, a component, or a circuit. The “module” may be a minimum unit of an integrated component element or a part thereof. The “module” may be a minimum unit for performing one or more functions or a part thereof. The “module” may be mechanically or electronically implemented. For example, the “module” according to various embodiments of the present disclosure may include at least one of an Application-Specific Integrated Circuit (ASIC) chip, a Field-Programmable Gate Arrays (FPGAs), and a programmable-logic device for performing operations which have been known or are to be developed hereafter.

According to various embodiments, at least part of a device (for example, modules or functions thereof) or a method (for example, operations) according to the various embodiments of the present disclosure may be embodied by, for example, an instruction stored in a computer readable storage medium provided in a form of a programming module. When the command is executed by one or more processors, the one or more processors may perform a function corresponding to the command. The computer-readable storage medium may be, for example, the memory. At least some of the programming modules may be implemented (for example, executed) by, for example, the processor. At least a part of the programming module may include, for example, a module, a program, a routine, a set of instructions and/or a process for performing one or more functions.

The computer-readable recording medium may include magnetic media such as a hard disk, a floppy disk, and a magnetic tape, optical media such as a Compact Disc Read Only Memory (CD-ROM) and a Digital Versatile Disc (DVD), magneto-optical media such as a floptical disk, and hardware devices specially configured to store and perform a program instruction (for example, programming module), such as a Read Only Memory (ROM), a Random Access Memory (RAM), a flash memory and the like. In addition, the program instructions may include high class language codes, which can be executed in a computer by using an interpreter, as well as machine codes made by a compiler. The aforementioned hardware device may be configured to operate as one or more software modules in order to perform the operation of various embodiments of the present disclosure, and vice versa.

Embodiments of the present disclosure provided in the present specifications and drawings are merely certain examples to readily describe the technology associated with embodiments of the present disclosure and to help understanding of the embodiments of the present disclosure, but may not limit the scope of the embodiments of the present disclosure. Therefore, in addition to the embodiments disclosed herein, the scope of the various embodiments of the present disclosure should be construed to include all modifications or modified forms drawn based on the technical idea of the various embodiments of the present disclosure.

FIGS. 1-8 are provided as an example only. At least some of the steps discussed with respect to these figures can be performed concurrently, performed in a different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples. It will be further understood that the examples provided in FIGS. 1-8 are not mutually exclusive.

The above-described aspects of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

While the present disclosure has been particularly shown and described with reference to the examples provided therein, it will be understood by those skilled in the art that various changes in form and details may be made therein without departing from the spirit and scope of the present disclosure as defined by the appended claims.

What is claimed is:

1. A method comprising:
displaying a first screen including a plurality of messages received from at least a first contact and a second contact;
detecting a selection of the first contact;
in response to the selection, hiding from the first screen a first message in the plurality that is received from the first contact.

2. The method of claim 1, wherein the selection of the first contact causes all messages in the plurality that are received from the first contact to be hidden from the first screen.

3. The method of claim 1, wherein the first screen is a group chat window.

4. The method of claim 1, displaying an indication that messages received from the first contact are being hidden.

5. The method of claim 1, further comprising displaying a list of contacts, wherein the selection of the first contact is made from the list.

6. The method of claim 1, wherein the first message remains hidden for a predetermined time period, the method further comprising displaying the first message in the screen after the time period passes.

7. The method of claim 1, wherein the first message remains hidden for a specified time period, the method further comprising:
displaying a second screen identifying a plurality of possible durations for the time period;
detecting an input selecting a first duration from the second screen, wherein the input causes the specified time period to have the first duration;
displaying the first message in the first screen after the time period passes.

8. The method of claim 1, wherein hiding the first message includes displaying a placeholder at a location in the first screen where the first message is displayed prior to being hidden, the placeholder including at least one of an image and text.

9. The method of claim 1, further comprising:
receiving a second message from the first contact while the first message is hidden; and
displaying a placeholder for the second message in the first screen.

10. The method of claim 1, wherein the first message remains hidden for a time period, the method further comprising displaying in the first screen a respective placeholder for each incoming message that is received from the first contact during the time period after the first message is hidden.

11. An electronic device, comprising a controller configured to:
display a first screen including a plurality of messages received from at least a first contact and a second contact;
detect a selection of the first contact;
in response to the selection, hide from the first screen a first message in the plurality that is received from the first contact.

12. The electronic device of claim 11, wherein the selection of the first contact causes all messages in the plurality that are received from the first contact to be hidden from the first screen.

13. The electronic device of claim 11, wherein the first screen is a group chat window.

14. The electronic device of claim 11, wherein the controller is further configured to display an indication that messages received from the first contact are being hidden.

15. The electronic device of claim 11, wherein the controller is further configured to display a list of contacts, wherein the selection of the first contact is made from the list.

16. The electronic device of claim 11, wherein the first message remains hidden for a predetermined time period, and the controller is further configured to display the first message in the screen after the time period passes.

17. The electronic device of claim 11, wherein the first message remains hidden for a specified time period, and the controller is further configured to:
display a second screen identifying a plurality of possible durations for the time period;
detect an input selecting a first duration from the second screen, wherein the input causes the specified time period to have the first duration;
display the first message in the first screen after the time period passes.

18. The electronic device of claim 11, wherein hiding the first message includes displaying a placeholder at a location in the first screen where the first message is displayed prior to being hidden, the placeholder including at least one of an image and text.

19. The electronic device of claim 11, wherein the controller is further configured to:
receive a second message from the first contact while the first message is hidden; and
display a placeholder for the second message in the first screen.

20. The electronic device of claim 11, wherein the first message remains hidden for a time period, and the controller is further configured to display in the first screen a respective placeholder for each incoming message that is received from the first contact during the time period after the first message is hidden.
